(19) United States
(12) Patent Application Publication
(10) Pub. No.: US 2010/0223638 A1
(43) Pub. Date: Sep. 2, 2010

(54) System and method for optimizing the scheduling of multimedia content

(76) Inventor: Robert B. Hubbard, Marina Del Rey, CA (US)

Correspondence Address: Benman, Brown & Williams, Suite 2740, 2049 Century Park East, Los Angeles, CA, 90067, US

(21) Appl. No.: 12/380,461

(22) Filed: Feb. 27, 2009

(51) Int. Cl. H04H 60/33; H04N 7/16; H04N 7/173

(52) U.S. Cl. 725/9; 725/28; 725/116; 725/118

(57) ABSTRACT

A system for optimizing the scheduling of multimedia content for playback on a subscriber's device. The novel system includes a first sub-system for obtaining data on a subscriber's actions on the device and a second sub-system for recommending a playback time for new multimedia content based on the data. In an illustrative embodiment, the first sub-system includes an applet stored in and executed by the device adapted to record the subscriber's actions on the device, including the actual playback times of and the subscriber's responses to content previously delivered to the device. The second sub-system includes a neural network artificial intelligence engine adapted to analyze the subscriber's recorded actions to predict at what time the new content should be scheduled for playback on the device to maximize subscriber acceptance of the new content.

### BACKGROUND OF THE INVENTION

1. Field of the Invention

The present invention relates to communications systems. More specifically, the present invention relates to systems and methods for delivering multimedia content to media storage devices.

2. Description of the Related Art

Advertisers generally want to target their advertisements toward the individuals who are most likely to respond favorably to their ads. At the same time, most consumers prefer to receive advertisements that fit with their personal interests, to learn about new products and services or promotions and sales on things they might want to purchase, and some consumers would prefer not to receive any advertisements at all. It would therefore be desirable to be able to deliver advertisements to targeted consumers based on their personal interests. This, however, is difficult if not impossible to accomplish using conventional advertising practices.

Most conventional advertising mediums—such as television or radio commercials, print ads in newspapers or magazines, and banners ads on Internet websites—rely on a “spray and pray” approach where advertisements are presented to a large general audience in hopes that some of the people who receive the ad will have a positive response. This approach can be inefficient and unreliable since there is no way to control who will receive the ad.

Advertisers typically use general demographic assumptions on the type of people who might be viewing a particular television show, magazine, website, etc., to help determine where to place an ad. These assumptions usually are not very accurate, resulting in advertisements being viewed by people who have no interest in them, while people who might have been interested never see them. Furthermore, with these advertising mediums, there is no guarantee that the targeted consumers will actually see or pay attention to the advertisements.

Direct mail, email, and telemarketing offer advertisers the ability to target specific individuals. However, these types of advertisements are usually unsolicited and unwanted, and are often discarded or ignored by the recipient. Advertisers generally target an individual based on a previous purchase, catalog request, group membership, or other action from which the advertiser obtained the individual's address, email, or phone number. This approach is therefore also based on loose assumptions that typically are not very accurate. Currently, there is no way of accurately targeting specific individuals with advertisements that match their interests.

Hence, a need exists in the art for an improved system or method for targeting specific individuals with advertisements based on their personal preferences that is more accurate and more efficient than conventional advertising practices.

### SUMMARY OF THE INVENTION

The need in the art is addressed by the system for optimizing the scheduling of multimedia content for playback on a subscriber's device of the present invention. The novel system includes a first sub-system for obtaining data on a subscriber's actions on the device and a second sub-system for recommending a playback time for new multimedia content based on the data. In an illustrative embodiment, the first sub-system includes an applet stored in and executed by the subscriber's device adapted to record the subscriber's actions on the device, including the actual playback times of and the subscriber's responses to multimedia content previously delivered to the device. The second sub-system includes a neural network artificial intelligence engine adapted to analyze the subscriber's recorded actions to predict at what time the new content should be scheduled for playback on the device to maximize subscriber acceptance of the new content.

### BRIEF DESCRIPTION OF THE DRAWINGS

FIG. 1 is a simplified block diagram of a system for delivering multimedia content to media storage devices designed in accordance with an illustrative embodiment of the present invention.

FIG. 2 is a simplified flow diagram of a scheduling engine designed in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention provides a novel system for determining the best time to schedule an advertisement based on monitored behavior patterns. In an illustrative embodiment, advertisements (or other types of multimedia content) are delivered to specific individuals via their cellular phones. The system may also be adapted for use with other types of media storage devices such as personal digital assistants (PDAs), MP3 players, gaming consoles, satellite radio receivers, digital television receivers, GPS navigation devices, or any other personal device with a processor, memory, and communication capability. Advertising via cellular phones offers advertisers the ability to target specific individuals, since cellular phones are typically personal devices used primarily by one person. Cellular phones are also more often with the consumer as compared to other advertising mediums such as televisions, and also offer displays and processing power capable of playing high quality multimedia content.

In a preferred embodiment, in order to avoid unsolicited spamming, consumers must opt-in or subscribe to the advertising service to receive ads via their cellular phones. In exchange, the consumers, or “subscribers”, may receive free or discounted products or services such as airtime, phones, music or game downloads, etc. Upon signing up for the service, subscribers are asked to create a subscriber profile that includes general demographic information (such as age, gender, etc.) as well as their personal preferences on the categories of ads they would prefer to receive (such as, for example, entertainment, sports, food, etc.). The advertising system then uses this information to select which subscribers receive which advertisements.

In accordance with the present teachings, the system includes a program running on each cellular phone that monitors the subscriber's behavior, particularly when the subscribers watch ads and how they respond to ads. The system then uses the monitored data to determine the best time to schedule an ad in order to obtain the best response.

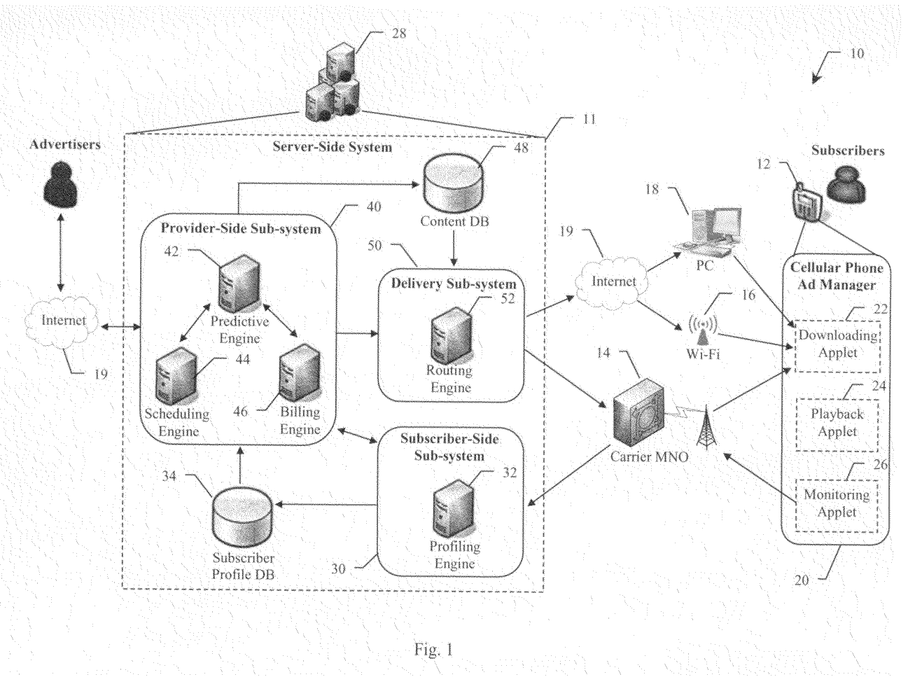

FIG. 1 is a simplified block diagram of a system 10 for delivering multimedia content to personal media storage devices designed in accordance with an illustrative embodiment of the present invention. In the illustrative embodiment, the system 10 includes a server-side system 11 adapted to deliver advertising content (preferably high quality multimedia ads, similar to television commercials) provided by the advertisers (or other content providers) to subscribers via their cellular phones 12. For simplicity, only one phone 12 is shown in FIG. 1. In the illustrative embodiment of FIG. 1, the server-side system 11 and phone 12 can communicate via carrier (through a mobile network operator 14) or a Wi-Fi connection 16, or by connecting the phone 12 to a computer 18 that is connected to the internet 19. Other communications protocols may also be used without departing from the scope of the present teachings.

The advertising service provides each phone 12 with an “ad manager” 20, which is client-side software stored in the phone's internal memory and executed by the phone's processor. The ad manager 20 includes a downloading applet 22 that manages the downloading and storing of ads received from the advertising system 10. In a preferred embodiment, the advertising system 10 embeds a scheduled playback time with each transmitted ad. Ads may be transmitted to the phone 12 at any time prior to the scheduled playback time. The downloading applet 22 stores the ads in the phone's memory until they are viewed by the subscriber. The downloading of ads is preferably invisible to the subscriber and does not interrupt or otherwise affect normal phone usage.

The phone ad manager 22 also includes a playback applet 24 that manages the playback of the ads. At the scheduled playback time, the playback applet 24 indicates on the phone's display that an ad is available for viewing. The subscriber can choose to watch the ad at that time, or save it to watch later. In a preferred embodiment, after an ad is played, the playback applet 24 initiates a procedure for confirming that the subscriber actually watched the ad. For example, the applet 24 may display instructions on the screen to press a particular keypad within a particular amount of time (say, for example, ten seconds). If the subscriber follows the instructions within the allotted time, he is awarded credits for watching the ad. The credits can then be used for purchasing goods or services. This procedure allows the system 10 to confirm to the advertiser not only that the ad was displayed, but also that the subscriber was actually watching it.

The phone ad manager 20 also includes a monitoring applet 26 for monitoring and recording the subscriber's behavior, particularly when he watches his ads and his responses to ads. The monitoring applet 26 may record, for example: whether an ad was downloaded successfully, at what time the ad was played, whether the subscriber watched the ad in its entirety (as indicated by his following of the subsequent screen instructions as described above), whether the ad was saved, the user's actions after viewing the ad, etc.

Each ad preferably includes one or more ways to measure or determine the user's response to the ad (e.g., whether or not the user had a positive response to the ad). In an illustrative embodiment, some ads may be followed with a query, such as “Did you like this ad?”, which indicates whether his response to the ad was positive or negative. This query may be combined with the confirmation procedure discussed above (i.e., the user is instructed to answer the query within the allotted time in order to receive credit for watching the ad).

In addition, some ads may include an offer from the advertiser, such as a coupon for free or discounted goods or services. The playback applet 24 gives the subscriber the option of deleting the offer, or saving it. The coupon may include a code that can be entered at online stores and/or a barcode that can be displayed on the phone and scanned by a merchant to receive the advertised offer. In a preferred embodiment, a unique code is given to each subscriber. When the code is used at a store, data is transmitted from the store to the advertising system 10, confirming that the code was used. This allows the system 10 to track which subscribers actually use their coupons and also when they use the coupons (use of a coupon indicates a favorable response to the ad).

Other methods may also be used to help the system 10 determine whether or not a subscriber responds favorably to an ad. For example, certain actions made by the user (such as initiating a search for the nearest store, visiting an advertised website or calling an advertised phone number, saving an ad, forwarding an ad to a friend, etc.) after viewing an ad may indicate a positive response.

In a preferred embodiment, the monitoring applet 26 also monitors and records other subscriber behavior patterns, such as phone usage, phone location, web browsing, purchases made via the phone, methods used to access or communicate digital information (e.g., Bluetooth, Wi-Fi, USB, etc.), and any other recordable metrics that may be useful to the system 10 for modeling the subscriber's behavior and predicting how he will respond to future ads. The monitoring applet 26 accumulates and saves the subscriber's behavior patterns and responses to ads in a data file and transmits the file to the server-side system 11 periodically (such as once a day). In the illustrative embodiment of FIG. 1, the monitored data files are transmitted from the phone 12 to the server 11 via carrier; however, the data may also be transmitted via Wi-Fi, satellite, USB, or any other communication method without departing from the scope of the present teachings.

In accordance with the present teachings, the advertising system 10 includes a server-side system 11 that uses the data obtained by the monitoring applet 26 to optimize the delivery of ads to the subscribers, by recommending the best subscribers to receive a particular ad, the best playback time to schedule an ad, the price for delivering the ad, and the best time and routing method to transmit the ads to the phones. In the illustrative embodiment, the server-side system 11 is implemented in software stored in and executed by a bank of servers 28.

The server-side system 11 includes a subscriber-side sub-system 30, a provider-side sub-system 40, and a delivery sub-system 50, plus a subscriber profile database 34 and a content database 48. The subscriber-side sub-system 30 receives the data monitored by the cellular phones 12 and uses the data to update a profile on each subscriber. The subscriber profiles are then stored in the subscriber profile database 34. Each subscriber profile includes information about the subscriber's demographic details and personal preferences, as well as his recorded behavior patterns and responses to ads. The provider-side sub-system 40 uses the subscriber profiles to help the advertisers (the content providers) refine their advertising campaigns, including the selection of which subscribers should be targeted to receive their ads, which are stored in the content database 48. The delivery sub-system 50 then uses the recorded subscriber behavior patterns to determine the optimal time and routing method to transmit the ads to the cellular phones 12 of each selected subscriber.

In operation, advertisers interact with the provider-side sub-system 40 to upload their ads to the content database 48 and specify the parameters of their advertising campaign, including the demographics they want to reach and when they want to schedule their ads for playback. The provider-side sub-system 40 uses the subscriber profiles stored in the subscriber database 34 to provide the advertisers with intelligent information about the specific individual behavior patterns of each subscriber as to their approval/acceptance or disapproval/rejection of particular advertising campaigns, and makes recommendations on an optimal advertising campaign. The advertisers may choose to use the system recommendations or override them and use their own campaign parameters.

In an illustrative embodiment, the provider-side sub-system 40 includes a predictive engine 42 for predicting how subscribers will respond to a particular advertising campaign based on their personal preferences and recorded behavior patterns stored in the profile database 34, and recommending which subscribers should be targeted to receive the ad in order to maximize the predicted subscriber acceptance of the campaign. In particular, the predictive engine 42 identifies the “high uptake” subscribers that are predicted to have a high probability of having a positive response to a particular ad campaign. The predictive engine 42 may also make recommendations on how to modify the campaign parameters in order to improve the predicted acceptance of an ad by selected “low uptake” subscribers (subscribers predicted to have a low probability of having a positive response to the ad campaign).

For a more detailed description of an illustrative provider-side sub-system 40 and predictive engine 42, see the co-pending patent application entitled “SYSTEM AND METHOD FOR PREDICTING THE OPTIMUM DELIVERY OF MULTIMEDIA CONTENT BASED ON HUMAN BEHAVIOR PATTERNS”, by R. B. Hubbard (Atty. Docket No. Hubbard-1), the teachings of which are incorporated herein by reference.

In accordance with the present teachings, the provider-side sub-system 40 also includes a scheduling engine 44 for recommending the best time to schedule an ad based on subscriber behavior patterns. As described in more detail below, the scheduling engine 44 recommends the best time slot that matches when the subscribers in the targeted demographic prefer to watch their ads, based on their monitored usage patterns (such as at what times the subscriber has previously watched his ads), which are recorded by the monitoring applet 26.

The provider-side sub-system 40 may also include a billing engine 46 for automatically computing the cost to the advertiser for a particular campaign. In a preferred embodiment, the billing engine 46 sets the price of an ad campaign for an advertiser based on ad type, frequency and volume of ads to be sent, campaign duration, and the acceptance rate of the targeted subscribers. An illustrative billing engine 46 is described in a co-pending patent application entitled “SYSTEM AND METHOD FOR OPTIMIZING THE PRICING OF MULTIMEDIA CONTENT DELIVERY”, by R. B. Hubbard (Atty. Docket No. Hubbard-5), the teachings of which are incorporated herein by reference.

After a campaign is approved by the advertiser, the delivery sub-system 50 transmits the ads to the selected subscribers' cellular phones 12. In a preferred embodiment, the delivery sub-system 50 includes a routing engine 52 that determines the best time and method for transmitting ads to the phones 12. Certain phones are capable of communicating using more than one form of data transmission. For example, a dual-mode phone may be equipped to communicate using a cellular network or a Wi-Fi network, which is typically cheaper and faster than cellular transmission. In a preferred embodiment, the routing engine 52 analyzes a subscriber's behavior patterns, particularly relating to his locations and the transmission methods available at those locations, to determine the best predicted time to send ads to the subscriber in order to minimize transmission costs. An illustrative routing engine 52 is described in a co-pending patent application entitled “SYSTEM AND METHOD FOR OPTIMIZING THE ROUTING OF MULTIMEDIA CONTENT”, by R. B. Hubbard (Atty. Docket No. Hubbard-3), the teachings of which are incorporated herein by reference.

After ads are downloaded to a subscriber's phone 12, at the scheduled playback time, the playback applet 24 on the phone will notify the subscriber that an ad is available for viewing. The subscriber can view the ad at that time, or save it and view it later. (Optionally, the advertiser may also specify an “expiration” date/time with the ad, so that if the subscriber has not watched the ad by the expiration time, the ad is deleted.) After the subscriber watches the ad, the monitoring applet 26 records the subscriber's responses and actions, including at what time the subscriber actually watched the ad. The recorded responses and monitored subscriber behavior patterns are then transmitted to the subscriber-side sub-system 30.

The subscriber-side sub-system 30 generates and maintains the subscriber profiles that are used by the provider-side sub-system 40 to predict an optimal campaign. The subscriber-side sub-system 30 receives the monitored data from each phone 12, and may also receive data from other sources such as merchants (regarding, for example, coupon use as discussed above) or a website that allows subscribers to manually modify their personal preferences and demographic information. The subscriber-side sub-system 30 then sifts through the received data and saves relevant information to the subscribers' profiles. For example, the subscriber-side system 30 keeps track of when subscribers watch their ads, how quickly they respond to ads, how often they use coupons, their actions after viewing an ad, etc.

In a preferred embodiment, the subscriber-side sub-system 30 includes a profile refining engine 32 for automatically determining the subscribers' personal preferences based on the subscribers' behavior patterns and responses to ads. In a particular embodiment, the subscriber is asked to specify only a few personal preferences upon registration, and the profiling engine 32 automatically refines the subscriber's preferences to greater detail based on their responses to ads. For example, subscribers may be asked upon registration whether or not they are interested in certain general categories, such as music, movies, sports, food, etc. Over time and continued use of the advertising system, the profiling engine 32 will refine the subscribers' profiles to include more details about their interests. For example, if a subscriber initially indicated that he liked sports, the profiling engine 32 may eventually determine, based on his response to various ads, which sports he likes, which teams he prefers, who his favorites athletes are, etc. The more detailed profiles can help to more accurately predict how the subscriber will respond to future ads. For a description of an illustrative subscriber-side sub-system 30 and profiling engine 32, see co-pending patent application entitled “SYSTEM AND METHOD FOR INTELLIGENTLY MONITORING SUBSCRIBER'S RESPONSE TO MULTIMEDIA CONTENT”, by R. B. Hubbard (Atty. Docket No. Hubbard-2), the teachings of which are incorporated herein by reference.

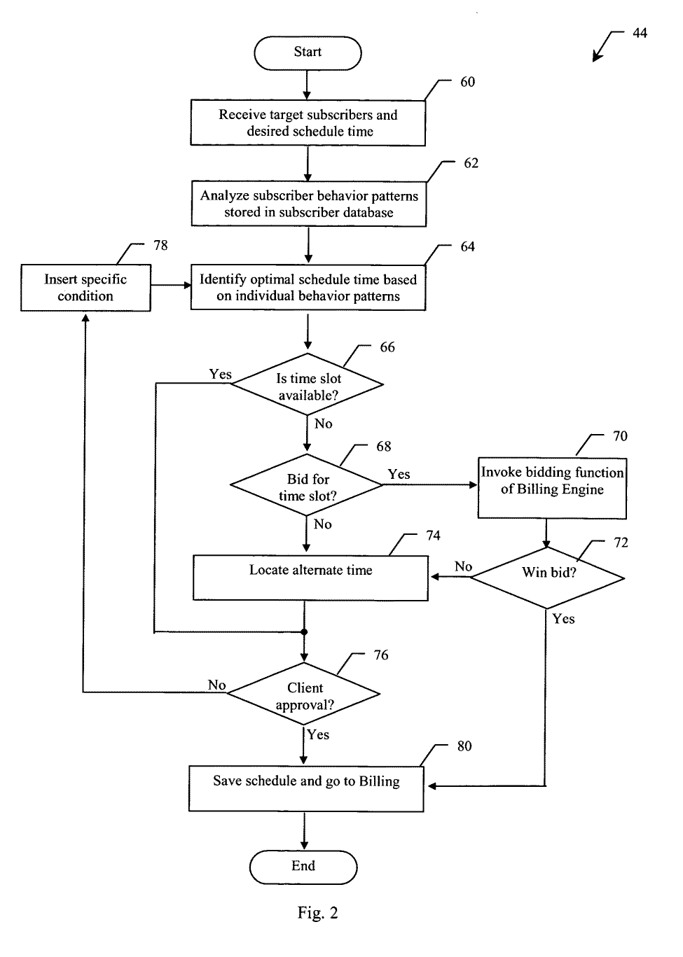

FIG. 2 is a simplified flow diagram of a scheduling engine 44 designed in accordance with an illustrative embodiment of the present invention.

First, at Step 60, the scheduling engine 44 receives information from the provider-side sub-system 40 on which subscribers have been selected to receive an ad. Optionally, the scheduling engine 44 may also receive a desired playback time, if this has been specified by the advertiser.

At Step 62, the scheduling engine 44 accesses and analyzes the data on the targeted subscribers stored in the subscriber profile database 34 and, at Step 64, identifies the optimal playback schedule based on the behavior patterns of the targeted subscribers.

In an illustrative embodiment, the scheduling engine 44 includes a neural network artificial intelligence (Al) engine adapted to analyze the subscribers' behavior patterns and recommend when to schedule the ads to achieve the best impact (a high percentage of positive responses) from the selected subscribers. In particular, the scheduling Al engine 44 looks at when the subscribers watched previously delivered ads, the scheduled playback time of those ads, and the subscribers' responses to the ads. The scheduling engine 44 searches for patterns in the subscribers' behavior that indicate at what times the subscribers prefer to watch ads. The scheduling engine 44 may also search for possible correlations between the subscribers' responses to ads and the time that the ads were viewed. Optionally, the scheduling engine 44 may divide the selected subscribers into two or more groups, each group having a different optimal playback time.

For example, say a fast food restaurant wants to send an ad to selected subscribers (preferably recommended by the predictive engine 42) at 11:00 am, targeting the lunch crowd. The scheduling engine 44 analyzes the selected subscribers' behavior patterns stored in the subscriber profile database 34 and learns that 40% of the targeted subscribers tend to watch their ads within an hour of the scheduled playback time, when the ad was scheduled at about 11:00 am, and usually have a positive response to food related ads viewed at this time. The other 60% of the subscribers, however, tend to save ads scheduled at 11:00 am and do not watch the ads until after 3:00 pm. For this second group of subscribers, the scheduling engine 44 learns from their monitored behavior patterns that food related ads have a higher uptake if viewed between 5:00 pm-6:00 pm. The scheduling engine 44 therefore recommends scheduling the ad at the closest available timeslot to 11:00 am for the first group of subscribers, and at the first available time slot between 5:00 pm-6:00 pm for the second group of subscribers.

In a preferred embodiment, the scheduling AI 44 is implemented with an adaptive neural network comprised of a plurality of interconnected neural nodes that perform the Al tasks described above. The first step to developing a neural node is to identify what adaptive functions the node is expected to perform. This is accomplished by creating a “rule set” to test the conditions of the business process. A rule set is essentially code that can be extracted into any preferred language, such as C++ or C#, as a set of hard-coded programmatic instructions with the ability to adjust its behavior related to changes in the environment in which it is monitoring. Once the rule set is determined and tested to meet all conditions, a stable engine then exists. It is at this point that the adaptive neural node can be created.

The AI engine 44 has to perform these tasks for potentially millions of subscribers and update profiles on a minute-by-minute basis in order to improve the experience for both the advertiser and the targeted subscriber. This is a high performance, highly adaptive task that needs an adaptable engine that has hard-coded “base” rules to work from, and then change as needed on its own, based on the behavior patterns of the targeted subscribers.

Returning to FIG. 2, at Step 66, the scheduling engine 44 determines if there are any timeslots available in the optimal time(s) identified in Step 64. In an illustrative embodiment, the scheduling engine 44 saves all scheduled ads to a master schedule that keeps track of when ads are scheduled for playback. The scheduling engine 44 may identify (in Step 64) multiple times or a time frame (such as between 5:00 pm-6:00 pm) as the optimal scheduled playback time. In Step 66, the scheduling engine 44 compares the identified optimal playback time(s) with the master schedule. If at least one timeslot is available during the identified times, that timeslot is recommended and, at Step 76, presented to the advertiser for approval. If several timeslots are available, the scheduling engine 44 may automatically select one, or at Step 76, present the available timeslots to the advertiser for his selection.

If none of the timeslots at the recommended times are available, then at Step 68, the scheduling engine 44 asks if the advertiser would like to bid for a time slot. Two ads cannot run at the same time; therefore, if an ad is already scheduled for the desired time, the scheduling engine 44 displays the conflict and gives the advertiser the option to compete for the timeslot.

If the advertiser does not want to bid for the timeslot, then at Step 74, the scheduling engine 44 locates an alternate time. The scheduling engine 44 searches for the next best time using the same process as that used in Step 64, but with the condition that only available timeslots can be selected.

If the advertiser wants to bid for the timeslot, then at Step 70, the scheduling engine 44 invokes the bidding function of the billing engine 46. The bidding function allows two different advertisers to compete for the same timeslot, paying a higher price for the timeslot until someone outbids the other.

If, at Step 72, the advertiser wins the bid, then the advertiser's ad is scheduled for playback at the specified timeslot and at Step 80, the scheduling engine 44 saves the schedule to the master schedule.

If, at Step 72, the advertiser does not win the bid, then at Step 74, the scheduling engine 44 searches for the next best available time slot.

At Step 76, the scheduling engine 44 displays the system's recommendations for the advertiser's approval.

If the advertiser does not approve the recommended schedule, then at Step 78, the scheduling engine 44 asks the advertiser to specify one or more conditions, or changes that he wants for the schedule. For example, the advertiser may specify that he wants the ad to run on Thursday at 11:00 am for all selected subscribers, regardless of what the system might recommend, or he may place limitations on the schedule such as, the ad must run between 10:00 am and 2:00 pm. The scheduling engine 44 then returns to Step 64 and searches for the optimal timeslot(s) given the new condition(s).

If the scheduling engine 44 recommended splitting the subscribers into multiple subsets, each with a different scheduled time, then Steps 66 to 76 may be repeated for each subset of subscribers.

After the advertiser approves the recommended schedule, then at Step 80, the scheduling engine 44 saves the schedule to the master schedule, and sends the advertiser to the billing engine to calculate the total bill for the scheduled campaign. The ad, along with its scheduled playback time, is then transmitted to the selected subscribers by the delivery sub-system 50.

Thus, the present invention has been described herein with reference to a particular embodiment for a particular application. Those having ordinary skill in the art and access to the present teachings will recognize additional modifications, applications and embodiments within the scope thereof For example, while the invention has been described with reference to an application for delivering advertisements to cellular phones, the present teachings may also used for delivering other types of multimedia content or for delivering to other types of media storage devices.

It is therefore intended by the appended claims to cover any and all such applications, modifications and embodiments within the scope of the present invention.

Accordingly,

What is claimed is:

1. A system for optimizing the scheduling of multimedia content for playback on a subscriber's device comprising:
first means for obtaining data on a subscriber's actions on said device and
second means for recommending a playback time for new multimedia content from a first content provider based on said data.

2. The invention of claim 1 wherein said data include times when said subscriber viewed content previously delivered to said device.

3. The invention of claim 2 wherein said data also include said subscriber's responses to said previously delivered content.

4. The invention of claim 3 wherein said second means includes a scheduling engine adapted to analyze said data to predict at what time said new content should be scheduled to maximize acceptance of said new content.

5. The invention of claim 4 wherein said scheduling engine includes a neural network artificial intelligence engine.

6. The invention of claim 4 wherein said second means includes means for initiating a bidding war if said predicted time was previously allocated to a second content provider.

7. The invention of claim 6 wherein said second means includes means for identifying an alternate playback time if said predicted time is unavailable.

8. The invention of claim 1 wherein said first means includes a first applet stored in and executed by said device adapted to record said subscriber's actions on said device.

9. The invention of claim 8 wherein said first means further includes a database for storing profiles on a plurality of subscribers.

10. The invention of claim 9 wherein said first means further includes a subscriber-side sub-system adapted to receive said recorded actions from said first applet and update said subscriber's profile accordingly.

11. The invention of claim 10 wherein said second means includes means for determining said recommended playback time based on said data stored in said subscriber's profile.

12. The invention of claim 1 wherein said system further includes a second applet stored in and executed by said device adapted to receive said new content and said recommended playback time and notify said subscriber at said recommended playback time that said new content is available for playback.

13. The invention of claim 1 wherein said multimedia content includes advertisements.

14. The invention of claim 1 wherein said device is a cellular phone.

15. A system for optimizing the scheduling of multimedia content for playback on a subscriber's media storage device comprising:
an applet stored in and executed by each of a plurality of subscribers' media storage devices, each applet adapted to record a subscriber's actions on said media storage device, and
a server-side system including:
a first sub-system for receiving said recorded actions from said applets and
a second sub-system for recommending a playback time for multimedia content based on said recorded actions.

16. A system for delivering multimedia content to media storage devices comprising:
a database for storing profiles on a plurality of subscribers;
a first applet stored in and executed by each of said media storage devices adapted to record a subscriber's actions on said media storage device;
a subscriber-side sub-system for receiving said recorded actions from said first applets and updating said subscribers' profiles accordingly;
a provider-side sub-system for selecting subscribers to receive new multimedia content;
a scheduling engine for determining an optimal playback time for said new content based on said profiles of said selected subscribers;
a delivery sub-system for delivering said new content and said optimal playback time to said media storage devices of said selected subscribers; and
a second applet stored in and executed by each of said media storage devices adapted to receive said content and said playback time and notify said subscriber at said optimal playback time that said content is available for playback.

17. A method for optimizing the scheduling of multimedia content for playback on a subscriber's device including the steps of:
obtaining data on a subscriber's actions on said device and
recommending a playback time for multimedia content based on said data.
